(19) United States
(12) Patent Application Publication
(10) Pub. No.: US 2007/0179416 A1
(43) Pub. Date: Aug. 2, 2007

(54) Deep vein pulsator leggings

(76) Inventors: Vincent William Obrien, Maroubra Junction, N.S.W. (AU); Shannon William Obrien, Maroubra Junction, N.S.W. (AU)

Correspondence Address: V W O'Brien, P O Box 848, Randwick Junction, North South Wales, 2031, AU

(21) Appl. No.: 10/575,553

(22) PCT Filed: Aug. 13, 2004
(86) PCT No.: PCT/AU04/01090

§ 371 Date: Mar. 16, 2007

(51) Int. Cl. A61H 9/00

(52) U.S. Cl. 601/152; 601/149; 601/148

(57) ABSTRACT

A device for preventing a medical condition known as deep vein thrombosis comprising of a pair of specially designed leggings (4) designed to be worn in conjunction with a power source to be worn attached to a belt (1) or as in post operative care; the power source (2) can be remotely located to power the leggings that will in turn massage the lower section of the legs at predetermined intervals that will in turn result in keeping the blood in the arteries and veins of the venus return system in the legs from congealing thereby causing the onset of a condition commonly known as deep vein thrombosis.

### BACKGROUND OF THE INVENTION

The present invention is directed to several embodiments. In at least one Embodiment, the invention is directed to an apparatus for the improving thee vascular blood flow In the extremities of individuals who are confined in such a manner such as long distance flights or as in the case of post operative care situations as is the case of anyone who is confined to a wheelchair for lengthy periods of time.

In at least one embodiment, the invention is directed to a system having an inflatable sleeve or collar that may be fitted around the limbs in such a way as to completely encase the limb such as the lower section of the leg from the knee to the foot. The sleeve is pneumatically connected to a completely self contained portable automatic power system that will supply pressurised air in the correct proportions to the sleeve to active the sleeve in such a way as to encourage the blood flow in the venous system to increase, resulting in the prevention and reducing the risk of D.V.T.

Anyone is at-risk when flying for extended periods of time or is in a convalescent situation and confined to a wheelchair, with the risks increased for the aged or infirm and for anyone who is overweight This situation is well known and there have been in the past many attempts to provide people with the means of overcoming the problem by designing systems to attempt to increase the blood flow through the limbs, that is the legs, in order to arrest the onset and formation of D.V.T.

There are numerous devices available for use, ranging from compression air bag boots to complete leggings. Many of these systems have various drawbacks, ranging from being complex machines, that are bulky and heavy, are cumbersome to operate, to highly sophisticated machines that extremely expensive to purchase and require highly experienced technical staff to operate.

Several attempts have been made to overcome these drawbacks.

This invention relates to overcoming these drawbacks.

Cited are the relevant patents in relation to this invention.

Invention Cited as C 350045

This invention is basically a messaging device that does not have the ability to purge the venous system in the leg to increase the blood flow.

Inventions Cited as W.0.2002/0042583 and W.O. 00/11215

Both of these inventions operate on an alternate inflation and deflation cycle. This method is prone to failure due to the fact that as the first stage collapses and the second stage inflates the resulting effect is that the venous flow can be forced back in the opposite direction, which can cause disastrous problems for the wearer of either of these two devices.

Invention W.O. 00/72797

This invention does not give out a sequential pressure movement upwards from the ankle, which is therefore unable to adequately vacate the venous red system to be effective. when used on a patient that is infirm or aged, the possibility presents itself that if a patient has a damaged venous return stem, such as impaired venous valves that do not operate correctly, and when this device is working on the said patient, the blood flow can then be reversed to accentuate the risk of D.V.T.

Invention US 2002/0115949

This system works on a cascading inflation system, relying on the greater pressure of the previous bladder section to trigger the next bladder into operation via a release valve causing a major pressure imbalance between the first and last bladder sections, thus impairing the efficiency of the system. The system relies upon the action of a vacuum cycle to reset the bladder for the next cycle.

Also this system relies on an external air supply which prevents the system from becoming portable.

The Invention E.P. 1249218

This invention does not embody the design of a travelling sequentially inflated cuff or bladder. Also this system is highly complex and requires the use of highly technical staff to operate the unit safely. The system is not portable.

The Invention U.S. Pat. No. 3,892,229 and U.S. Pat. No. 4,922,893

These inventions are not self contained or portable, and do not have the design of a travelling sequential inflatable bladder or cuff. Relies on an outside source of air to power the system.

To understand what D.V.T. is, one has to look at what is involved in the formation of a blood clot.

The cardiovascular system of the body is basically comprised of a heart which supplies the blood pressure that enables the supply to travel throughout the body. Then there is the lungs which eliminate the carbon dioxide from the blood and replenish the blood with flesh oxygen. The kidneys which eliminate the solid wastes from the blood, and then there are the thousands of veins capillaries and arteries which carry the blood throughout the entire body.

The heart has the massive job to pump the blood supply down to the feel which are the sections of the body that are at the greatest distance from the heart, and the heart has to deliver enough pressure to ensure that the blood will have enough energy to make the journey back up the leg and return to the heart Now to assist the heart to do this work, contained within the leg is a particular section of both the main arterial supply and return systems, called the venous system, and within this particular section, there is an arrangement of one way non return valves throughout these arteries. Now to assist the heart to do this work, there is a muscle located below the knee called the calf muscle. Now when a person is normally upright and active or walking the secondary action for the calf muscle is such that it exerts pressure on the entire venous system, causing the venous return system to become pressurised, and as such the arterial blood contained within the venous system seeks to escape in the correct direction back up the legs, into the body and finally back to the heart. This is achieved by way of the non return valves which are located throughout the venous system that will only allow the blood to travel in the correct direction.

When the body is at rest for extended periods of time, the respiration and blood circulation will slow down to a point that the blood supply is not strong enough to adequately keep the blood within the venous return system from clotting.

The optimum way to solve this problem is to apply a device that will prevent blood clots forming in the first place by applying a pressure device that will actively massage the, lower portion of the leg, that is section of the leg between the knee and the foot sufficiently enough to mimic the action of the calf muscle when a person is actively walking or standing. This mimicking action will normally be sufficiently strong enough to maintain the correct blood flow which in turn prevents the formation of blood clots within the venous return system. Such a device would need to be extremely portable, lightweight and comfortable to wear, will not interfere with the avionics of an aircraft, be easy to fit and operate with little or no assistance or instruction, with the exception of the aged or infirm.

### SUMMARY OF THE DEEP VEIN PULSATOR LEGGINGS

This invention relates to reducing the incidence of Deep Vein Thrombosis. That is the formation of blood clots in the veins and arteries of the lower legs of the human body caused by long periods of inactive such as sitting in an aircraft for long periods of time, or convalescing in a wheelchair or bed during post operative care after an operation, or long periods of hospitalisation.

The lack of movement of the human body over extended periods of time, causes a gradual decline of the blood pressure, and due to the body being in an upright position, will result in the circulation of the blood within the lower extremities, that is the lower leg and the upper thigh areas to slow sown to such a degree that the body's own blood pressure can no longer continue to clear the veins and arteries within the venous return system adequately enough to keep the venous return system free. The resulting effect can cause the build up of blood within the venous return system to congeal into blood clots. These clots are called thrombic clots or plugs, which then can be dislodged to travel through to other parts of the body with the potential to cause life threatening situations or death.

The action necessary to prevent the formation of thrombic clots is to apply a systemic sudden and rhythmic sequential pro wave to the area of the lower limbs between the ankle and the knee, beginning at the ankle and working upwards towards the knee.

This pressure wave will result in vacating the venous return system by driving the blood up the venous return system past the knee, and into the groin area, where the body's own cardiovascular system can readily accommodate the blood flow once more. This action mimics pan of the action of the calf muscle of the lower leg when a person is mobile. The calf muscle will normally exert pressure on the venous return system in such a way as to assist in the blood circulation of the lower limbs, when a person is standing or walking, or in any way active in an upright position.

To assist in the understanding of this invention, reference will now be made to the accompanying drawings which shows the portable example of this invention with the power source attached to the person's waist or belt when used in mobile situation.

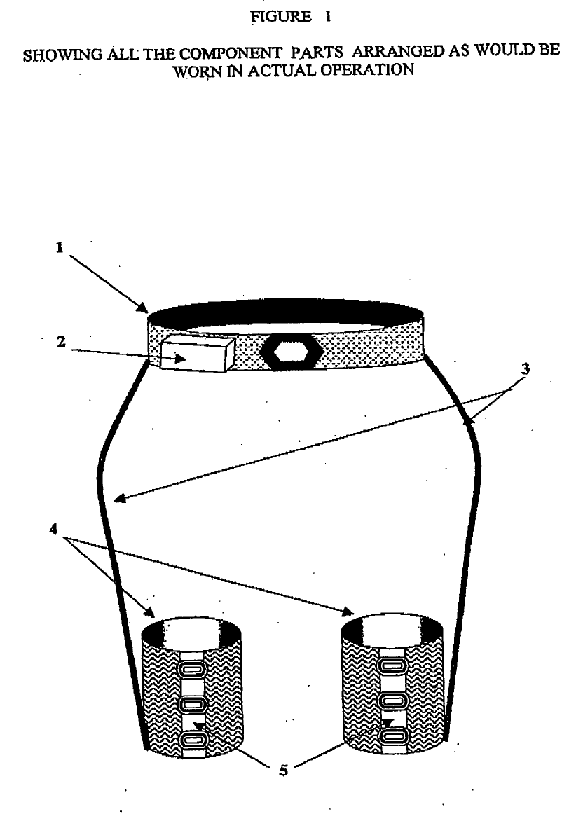

FIG. 1 shows the complete assembly as worn by the user. This assembly shows the waist belt and buckle 1. The power source 2 complete within it's own housing attached to the waist belt 1. The air supply lines 3 connecting the power source to both the left and right leg sleeves 4. The sleeve tensioning straps 5 are used to adjust the sleeves to fit the user's leg shape.

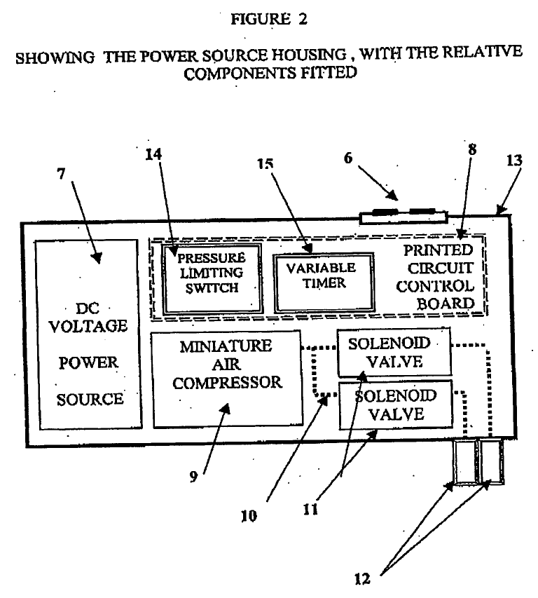

FIG. 2 shows the power source housing assembly with the necessary components fitted and contained within the housing. The start stop control switch 6 toed to activate the power source at will. The D.C. voltage rechargeable power pack 7 used to power the unit. The printed circuit control board 8 which controls all the necessary functions of the unit. The miniature compressor 9. The air supply lines 10. The two controlling solenoid valves 11 which an: connected to the left and right air supply plug outlets 12.

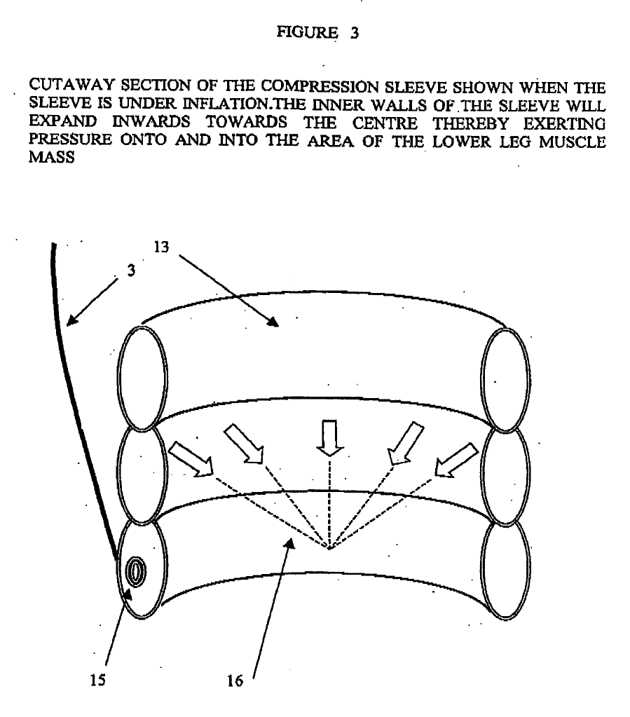

FIG. 3 Shows the cutaway section of the bladder section 13 of the compression sleeve 4 as shown when the compression sleeve 4 is actually under compression. The air supply line 3 supplies compressed air from the air supply outlets of the power unit of FIG. 2 to the sleeve assembly via the connecting button 15 located on the sleeve assembly. The direction of the inflation of the compression sleeve 13 is indicated by the directional arrows 16.

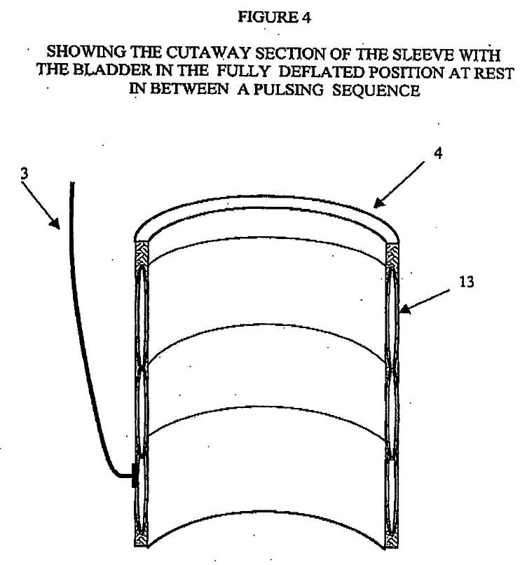

FIG. 4 Shows the cutaway section of the complete sleeve assembly, with the bladder section in a fully deflated position

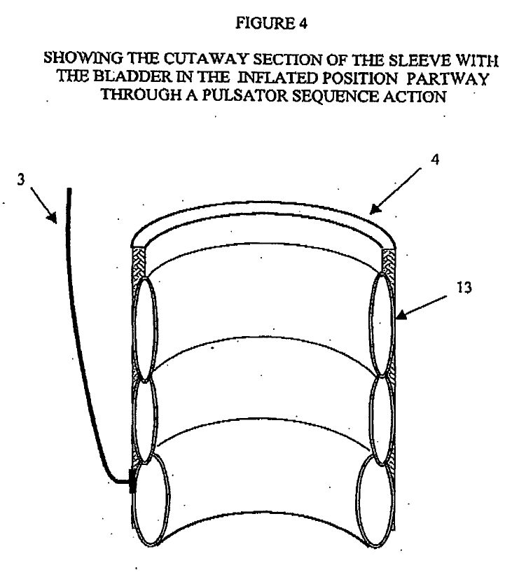

FIG. 5 Shows the same cutaway section as in FIG. 4, but with the bladder partially under inflation

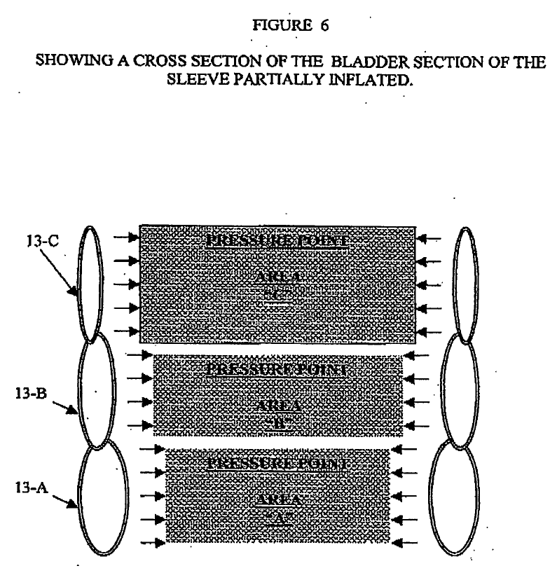

FIG. 6 Shows a cross section of the bladder partially inflated. The bladder is divided into compartments, with each compartment connected to each other by pressure tubes. These tubes control the sequential inflation by allowing the lowest or first segment 13-A to pressurise before allowing the next segment to become in turn to become pressurised. FIG. 6 shows the inflation sequence of the bladder compartments, with the lowest compartment inflated at pressure point “A” as indicated in FIG. 6. The pressure is greater than the compartment 13-B as indicated at pressure point “B”, which in turn has a greater pressure of the compartment 13-C as indicated at pressure point “C”. This action will only allow the bladder to inflate from the bottom up.

The compression sleeve 4 consists of an outer flexible casing that is constructed of an inelastic material designed to allow the expansion of the inflatable/deflatable bladder to move inwards toward the centre of the sleeve, as indicated by the arrows 16 shown in the FIG. 3 To assist in the comfort of the person using the apparatus, a set of adjusting straps 5 are shown fitted to the front section of the sleeve assembly 4 to be adjusted individually when necessary. Encased within the compression sleeve 4 as shown in FIG. 4, is an inflatable/deflatable bladder 13 moulded in one piece, and designed as such to have a plurity of compartments incorporated within the design in such a manner as to permit the bladder 13 to inflate sequentially in a non stop flowing movement from the lower most section of the bladder upwards to the top of the bladder until the complete bladder is under fill inflation. The bladder 13 is inflated by the miniature air compressor 9 via the air supply lines 3 activated by the solenoid valves 11 which are controlled by the printed circuit control board assembly 8.

When the apparatus is worn and in use the following action is described thus,

The Deep Vein Pulsator Legging apparatus is designed to mimic part of the action of the calf muscle when a person is mobile or standing in an upright position. This natural body action is responsible for assisting the cardiovascular system to continue to maintain the flow of blood through the venous return system, thereby eliminating a build up of oxygen depleted blood, which is inclined to develop into blood clots to further enlarge to form thrombic clots. These Thrombosis are potentially very life threatening end deadly.

Now when the Deep Vein Pulsator Legging apparatus is fitted aid worn as indicated by the layout in FIG. 1 the apparatus is now ready to be used.

To operate the unit, press the start button 6 located on the power source 2 which is connected to the waist belt 1. This action powers up the unit by realising direct current power from the direct current power source 7 into the printed circuit control board 8 which has a built in timer 15 as part of the circuitry. The timer 15 in turn activates the miniature air compressor 9 which then supplies via the air supply lines 3 the necessary air pressure to inflate the leg sleeve assemblies 4 to a predetermined pressure which is controlled by a miniature air pressure limit switch 14 that is contained within the circuit board 8. At an interval also determined by the timer section 15 of the circuit board 8, the two solenoid valves 11 are then activated to release the air pressure contained within the leg sleeve assemblies 4 via the air supply lines 3 by allowing the pressurised air to escape into the atmosphere. This action is then repeated for as long as required.

FIG. 6 Shows a cross section of the bladder section 13 containing only a three compartment bladder configuration as part of a leg sleeve assembly 4, which has began a compression cycle. The actual number of bladder compartments will depend on the size of thee leg assembly as required to fit each individual person. This illustration clearly shows that as the leg sleeve assemblies 4 become pressurised, the bladder 13 will begin to inflate from the lowest compartment progressively up until all the compartments are fully inflated. The first compartment of the bladder, that is segment 13-A of FIG. 6 will pressurise to the desired setting pressure which will then allow the next segment 13-B to inflate to the corresponding desired pressure setting which will then in turn allow the final segment to become fully pressurised. This action occurs in a flowing non stop sequentous movement until the leg sleeve assembly bas been fully inflated.

The action of the sleeve assemblies 1 being inflated, will result in creating and exerting a fully encapsulating travelling pressure wave acting with a direct pressure over the complete leg area beginning from the foot and travelling up the leg area to the knee, with the pressure being transmitted through the muscle and tissue area into the actual centre of the leg itself. The complete leg sleeve assemblies 1 once becoming fully pressurised, with then begin to deflate due to the action of timer section 15 of tee printed circuit board 8 which will activate the two solenoid valves 11 to release the compressed air contained within the leg sleeve assemblies 1 to escape into the atmosphere.

The resulting action will have the desired effect on the leg area, that is the leg area between the He and the knee. This action can be described as a travelling sequential pressure wave in the leg encapsulating the whole leg, beginning at the foot and travelling upwards within the muscle and tissue of the leg to the knee, resulting in the involuntary pressure acting directly upon the main arteries and veins of the venous return system Thus resulting in the purging of the blood that is contained within the venous return system upwards towards the upper part of the leg, that is the leg area past the knee and into the groin area of the body to be accommodated by the body's own cardiovascular system. This action is repeated in a constant rhythmic motion in both the left and right legs alternately as an ongoing action which will assist in the prevention of the onset of a medical condition known as Deep Vein Thrombosis.

By wearing this apparatus described in this patent application, the action of the harness as defined within this patent application, win create the alternate a rhythmic sequential travelling pressure wave to act on the lower leg area, that is the leg area between the foot and the knee, to purge the blood contained within the main arteries and veins of the venous return system of the leg, which in turn prevents the blood from flowing down to such a dangerous level that thrombic blood clots are likely to occur within the venous return system to flier develop into an acute medical condition known as Deep Vein Thrombosis or D.V.T. as is commonly called.

1. A device for preventing deep vein thrombosis, said device comprising:
at least one sleeve adapted to be disposed substantially around a lower limb of a wearer, each sleeve comprising a bladder adapted to substantially encapsulating said lower limb of said wearer, said bladder section being divided into a plurality of inflatable chambers arranged co-axially to form a sequence of chambers, wherein said inflatable chambers are in fluid communication with each other in a manner such that fluid in any one of said chambers is allowed to pass to a next chamber in said sequence of chambers once a fluid pressure reaches a predetermined value; and
a pneumatic pressure source, in fluid communication with a first inflatable chamber in said sequence of chambers of each sleeve, for periodically inflating and deflating said chambers of said sleeves.

2. The device according to claim 1 wherein each sleeve further comprises an inelastic outer casing thereby restricting expansion of said chambers during inflation to an inwardly direction.

3. The device according to claim 1 or 2 wherein said pneumatic pressure source comprises:
a compressor for supplying pneumatic pressure; and
at least one solenoid for controllably communicating said pneumatic pressure to said at least one sleeve.

4. The device according to any one of claims 1 to 3 wherein each sleeve further comprises tension straps for adjusting said sleeve to fit the shape of said lower limb of said wearer.

5. The device according to any one of claims 1 to 4 wherein said pneumatic pressure source is portable.

6. A method of preventing deep vein thrombosis, said method comprising the steps of:
providing a sleeve for substantially encapsulating a lower limb of a wearer, said sleeve comprising a bladder being divided into a plurality of inflatable chambers arranged co-axially to form a sequence of chambers;
inflating a first chamber located at a distal end of said lower limb of said wearer;
sequentially inflating subsequent chambers until all chambers of said bladder are inflated, thereby providing a source of compression pressure to said lower limb which grows substantially continuously from said distal end towards a proximal end of said limb; and
deflating said chambers.

7. A device for preventing deep vein thrombosis substantially as described herein with reference to the accompanying drawings.
